(19) United States
(12) Patent Application Publication
(10) Pub. No.: US 2012/0153776 A1
(43) Pub. Date: Jun. 21, 2012

(54) Ultrasound Transducer with Improved Adhesion Between Layers

(75) Inventors: Richard Guéron, Sophia Antipolis (FR); Jean-Pierre Malacrida, Sophia Antipolis (FR)

(73) Assignee: GENERAL ELECTRIC COMPANY, Schenectady, NY (US)

(21) Appl. No.: 12/970,564

(22) Filed: Dec. 16, 2010

(51) Int. Cl. G10K 9/122; H04R 31/00

(52) U.S. Cl. 310/334; 29/594

(57) ABSTRACT

Ultrasound transducers and methods of forming ultrasound transducers are provided. An ultrasound transducer can include an acoustic stack including: a dematching layer and a flexible circuit including a nonconductive layer and a conductive material. The conductive material can include a plurality of substantially parallel strips. Adhesive can be provided between the dematching layer and the flexible circuit such that it contacts the strips of conductive material and portions of the nonconductive layer between the strips of conductive material. A plurality of substantially parallel cuts can extend through the dematching layer, through the adhesive and into the nonconductive layer without cutting into the strips of conductive material. The flexible circuit can include a ground area and the strips of conductive material and cuts can be located thereon. The adhesive can encapsulate each strip of conductive material on three surfaces, including a top surface and two sides of each strip.

### RELATED APPLICATIONS

[Not Applicable]

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

Embodiments of the present technology generally relate to ultrasound transducers, and more particularly to adhesion between layers of materials in an acoustic stack of an ultrasound transducer.

FIG. 5A illustrates a perspective view of layers of an acoustic stack 500 of a prior art ultrasound transducer. The acoustic stack 500 includes a plurality of layers 505 including a dematching layer 506 and a flexible circuit that includes a non-conductive layer 502, e.g., comprising Kapton®, and a conductive layer 504, e.g., comprising copper. The conductive layer 504 is secured to the dematching layer 506 using an adhesive 505 (shown in FIG. 7A), and then a dicing operation is executed to provide a plurality of substantially parallel cuts 508 that extend through the dematching layer 506, through the conductive layer 504 and into the non-conductive layer 502.

FIG. 6A illustrates a top view of a portion of the top surface 600 of the flexible circuit of the prior art ultrasound transducer of FIG. 5A. The top surface 600 includes an active area 602 and a ground area 604. The surface of the active area 602 has portions where the non-conductive layer 502 is exposed (indicated by the darker portions) and areas where the conductive layer 504 is exposed (indicated by the lighter portions). On the other hand, the surface of the ground area 604 is almost completely conductive layer 504 (indicated by the lighter portions) with very little of the non-conductive layer 502 (indicated by the darker portions) being exposed.

FIG. 7A illustrates a side-sectional view of the acoustic stack 500 of the prior art ultrasound transducer depicted in FIG. 5A taken at the ground area 604 depicted in FIG. 6A. FIG. 7A depicts the adhesive 505 between the conductive layer 504 and the dematching layer 506, and also depicts a plurality of substantially parallel cuts 508 that extend through the dematching layer 506, through the conductive layer 504 and into the non-conductive layer 502

It has been found that known ultrasound transducers configured as depicted in FIGS. 5A, 6A and 7A exhibit poor adherence at the ground area 604 between the conductive layer 504 and the dematching layer 506.

Thus, there is a need for ultrasound transducers with improved adhesion between layers of materials in the acoustic stack.

### BRIEF SUMMARY OF THE INVENTION

Embodiments of the present technology include ultrasound transducers and methods of forming ultrasound transducers.

In an embodiment, an ultrasound transducer includes an acoustic stack comprising: a dematching layer; a flexible circuit including a nonconductive layer and a conductive material disposed on the nonconductive layer, the conductive material including a plurality of substantially parallel strips; adhesive provided between the dematching layer and the flexible circuit such that the adhesive contacts the strips of conductive material and portions of the nonconductive layer between the strips of conductive material; and a plurality of substantially parallel cuts that extend through the dematching layer, through the adhesive and into the nonconductive layer without cutting into the strips of conductive material.

In an embodiment, an ultrasound system includes a transducer including an acoustic stack as described above.

In an embodiment, a method of forming an acoustic stack of an ultrasound transducer includes: attaching a plurality of substantially parallel strips of conductive material to a nonconductive layer of a flexible circuit; using an adhesive to bond a dematching layer to the strips of conductive material and portions of the nonconductive layer between the strips of conductive material; and providing a plurality of substantially parallel cuts that extend through the dematching layer, through the adhesive and into the nonconductive layer without cutting into the strips of conductive material.

In certain embodiments, the flexible circuit includes a ground area and the strips of conductive material and the cuts are located on the ground area.

In certain embodiments, the adhesive encapsulates each strip of conductive material on three surfaces, including a top surface and two sides of each strip of conductive material, and a bottom surface of each strip of conductive material is attached to the nonconductive layer.

In certain embodiments, the conductive material comprises copper.

In certain embodiments, the nonconductive material comprises Kapton®.

### BRIEF DESCRIPTION OF THE DRAWINGS

FIG. 1 illustrates an ultrasound system formed in accordance with an embodiment of the present invention.

FIG. 2 illustrates a three-dimensional (3D) capable miniaturized ultrasound system formed in accordance with an embodiment of the present invention.

FIG. 3 illustrates a mobile ultrasound imaging system formed in accordance with an embodiment of the present invention.

FIG. 4 illustrates a hand carried or pocket-sized ultrasound imaging system formed in accordance with an embodiment of the present invention.

FIG. 5A illustrates a perspective view of layers of an acoustic stack of a prior art ultrasound transducer at the ground area of a flexible circuit.

FIG. 5B illustrates a perspective view of layers of an acoustic stack of an ultrasound transducer in accordance with an embodiment of the present invention at the ground area of a flexible circuit.

FIG. 6A illustrates a top view of a portion of the top surface of the flexible circuit of the prior art ultrasound transducer of FIG. 5A.

FIG. 6B illustrates a top view of a portion of the top surface of the flexible circuit of the inventive ultrasound transducer of FIG. 5B.

FIG. 7A illustrates a side-sectional view of the acoustic stack of the prior art ultrasound transducer depicted in FIG. 5A taken at the ground area depicted in FIG. 6A.

FIG. 7B illustrates a side-sectional view of the acoustic stack of the inventive ultrasound transducer depicted in FIG. 5B taken at the ground area depicted in FIG. 6B.

FIG. 8 illustrates a method of forming an acoustic stack of an ultrasound transducer in accordance with an embodiment of the present invention.

### DETAILED DESCRIPTION OF CERTAIN EMBODIMENTS

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings. To the extent that the figures illustrate diagrams of the functional blocks of various embodiments, the functional blocks are not necessarily indicative of the division between hardware circuitry. Thus, for example, one or more of the functional blocks (e.g., processors or memories) may be implemented in a single piece of hardware (e.g., a general purpose signal processor or random access memory, hard disk, or the like). Similarly, the programs may be stand alone programs, may be incorporated as subroutines in an operating system, may be functions in an installed software package, and the like. It should be understood that the various embodiments are not limited to the arrangements and instrumentality shown in the drawings.

As used herein, an element or step recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

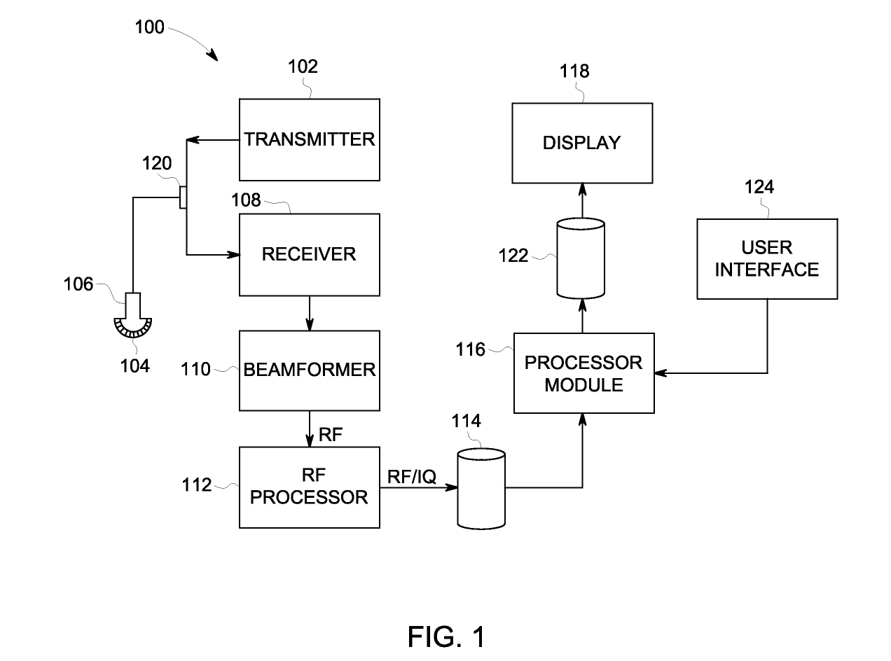

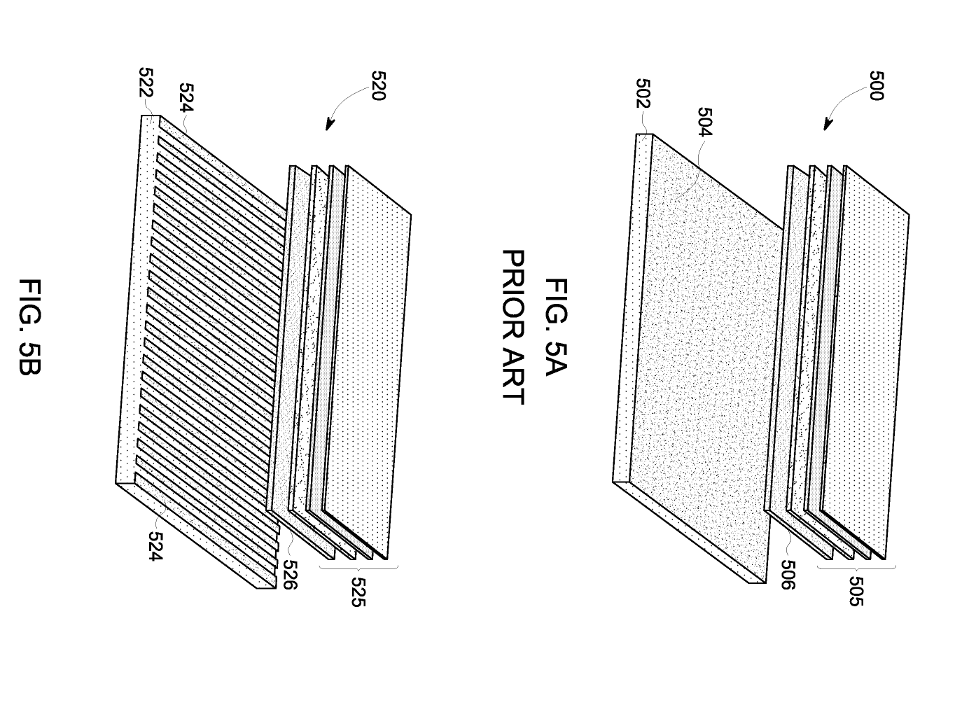

FIG. 1 illustrates an ultrasound system 100 including a transmitter 102 that drives an array of elements 104 (e.g., piezoelectric elements) within a probe/transducer 106 to emit pulsed ultrasonic signals into a body. The probe 106 may be configured to include an acoustic stack as depicted in FIGS. 5B, 6B and 7B. The elements 104 may be arranged, for example, in one or two dimensions. A variety of geometries may be used. The system 100 may have a probe port 120 for receiving the probe 106 or the probe 106 may be hardwired to the system 100.

The ultrasonic signals are back-scattered from structures in the body, like fatty tissue or muscular tissue, to produce echoes that return to the elements 104. The echoes are received by a receiver 108. The received echoes are passed through a beamformer 110 that performs beamforming and outputs a radiofrequency (RF) signal. The RF signal then passes through an RF processor 112. Alternatively, the RF processor 112 may include a complex demodulator (not shown) that demodulates the RF signal to form in-phase and quadrature (IQ) data pairs representative of the echo signals. The RF or IQ signal data may then be routed directly to a memory 114 for storage.

The ultrasound system 100 also includes a processor module 116 to process the acquired ultrasound information (e.g., RF signal data or IQ data pairs) and prepare frames of ultrasound information for display on display 118. The processor module 116 is adapted to perform one or more processing operations according to a plurality of selectable ultrasound modalities on the acquired ultrasound information. Acquired ultrasound information may be processed and displayed in real-time during a scanning session as the echo signals are received. Additionally or alternatively, the ultrasound information may be stored temporarily in memory 114 or memory 122 during a scanning session and then processed and displayed in an off-line operation.

A user interface 124 may be used to input data to the system 100, adjust settings, and control the operation of the processor module 116. The user interface 124 may have a keyboard, trackball and/or mouse, and a number of knobs, switches or other input devices such as a touchscreen. The display 118 includes one or more monitors that present patient information, including diagnostic ultrasound images to the user for diagnosis and analysis. One or both of memory 114 and memory 122 may store two-dimensional (2D) and/or three-dimensional (3D) datasets of the ultrasound data, where such datasets are accessed to present 2D and/or 3D images. Multiple consecutive 3D datasets may also be acquired and stored over time, such as to provide real-time 3D or four-dimensional (4D) display. The images may be modified and the display settings of the display 118 also manually adjusted using the user interface 124.

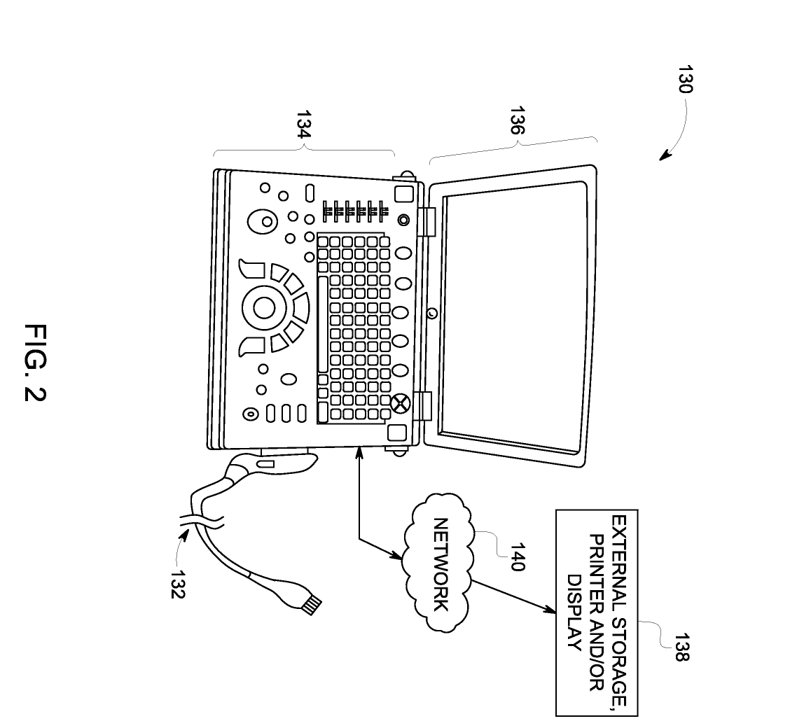

FIG. 2 illustrates a 3D-capable miniaturized ultrasound system 130 having a probe/transducer 132 that may include an acoustic stack as depicted in FIGS. 5B, 6B and 7B. The probe 132 may be configured to acquire 3D ultrasonic data. For example, the probe 132 may have a 2D array of transducer elements 104 as discussed previously with respect to the probe 106 of FIG. 1. A user interface 134 (that may also include an integrated display 136) is provided to receive commands from an operator.

As used herein, “miniaturized” means that the ultrasound system 130 is a handheld or hand-carried device or is configured to be carried in a person's hand, pocket, briefcase-sized case, or backpack. For example, the ultrasound system 130 may be a hand-carried device having a size of a typical laptop computer, for instance, having dimensions of approximately 2.5 inches in depth, approximately 14 inches in width, and approximately 12 inches in height. The ultrasound system 130 may weigh about ten pounds, and thus is easily portable by the operator. The integrated display 136 (e.g., an internal display) is also provided and is configured to display a medical image.

The ultrasonic data may be sent to an external device 138 via a wired or wireless network 140 (or direct connection, for example, via a serial or parallel cable or USB port). In some embodiments, external device 138 may be a computer or a workstation having a display. Alternatively, external device 138 may be a separate external display or a printer capable of receiving image data from the hand carried ultrasound system 130 and of displaying or printing images that may have greater resolution than the integrated display 136. It should be noted that the various embodiments may be implemented in connection with a miniaturized ultrasound system having different dimensions, weights, and power consumption.

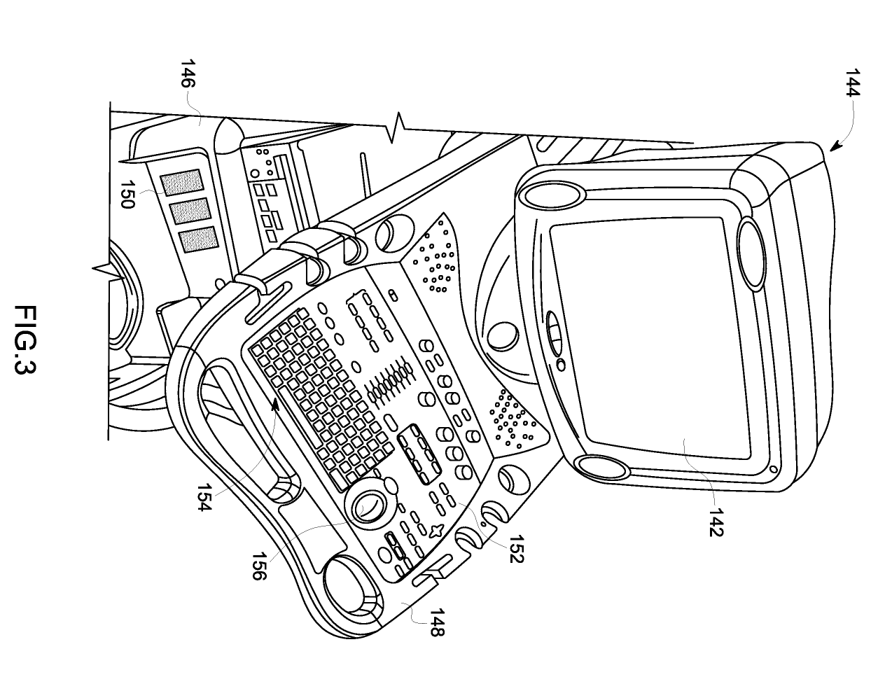

FIG. 3 illustrates a mobile ultrasound imaging system 144 provided on a movable base 146. The ultrasound imaging system 144 may also be referred to as a cart-based system. A display 142 and user interface 148 are provided and it should be understood that the display 142 may be separate or separable from the user interface 148. The system 144 has at least one probe port 150 for accepting probes/transducers (not shown) that may include an acoustic stack as depicted in FIGS. 5B, 6B and 7B.

The user interface 148 may optionally be a touchscreen, allowing the operator to select options by touching displayed graphics, icons, and the like. The user interface 148 also includes control buttons 152 that may be used to control the ultrasound imaging system 144 as desired or needed, and/or as typically provided. The user interface 148 provides multiple interface options that the user may physically manipulate to interact with ultrasound data and other data that may be displayed, as well as to input information and set and change scanning parameters. The interface options may be used for specific inputs, programmable inputs, contextual inputs, and the like. For example, a keyboard 154 and track ball 156 may be provided.

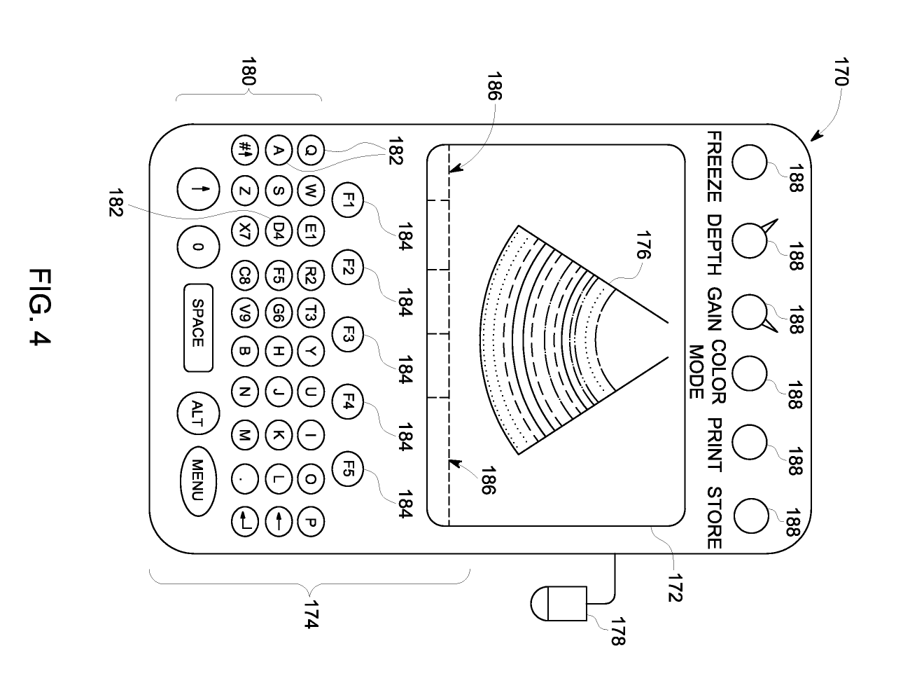

FIG. 4 illustrates a hand carried or pocket-sized ultrasound imaging system 170 wherein display 172 and user interface 174 form a single unit. By way of example, the pocket-sized ultrasound imaging system 170 may be approximately 2 inches wide, approximately 4 inches in length, and approximately 0.5 inches in depth and weighs less than 3 ounces. The display 172 may be, for example, a 320×320 pixel color LCD display (on which a medical image 176 may be displayed). A typewriter-like keyboard 180 of buttons 182 may optionally be included in the user interface 174. A probe/transducer 178 that may include an acoustic stack as depicted in FIGS. 5B, 6B and 7B is interconnected with the system 170.

Multi-function controls 184 may each be assigned functions in accordance with the mode of system operation. Therefore, each of the multi-function controls 184 may be configured to provide a plurality of different actions. Label display areas 186 associated with the multi-function controls 184 may be included as necessary on the display 172. The system 170 may also have additional keys and/or controls 188 for special purpose functions, which may include, but are not limited to “freeze,” “depth control,” “gain control,” “color-mode,” “print,” and “store.”

FIGS. 5A, 6A and 7A (described in the background) depict acoustic stacks from prior art ultrasound probes/transducers. It has been found that known ultrasound transducers configured as depicted in FIGS. 5A, 6A and 7A exhibit poor adherence at the ground area 604 between a conductive layer 504 of a flexible circuit and an adjacent dematching layer 506.

Certain embodiments of the inventive ultrasound probes/transducers described herein provide improved adherence at the ground area between a dematching layer and a flexible circuit. Certain embodiments provide such improved adherence without degrading acoustic performance, without using harsh or dangerous adhesives, and without increasing the cost of the flexible circuit.

In certain embodiments, the inventive ultrasound probes/transducers described herein can be used in connection with any ultrasound system, including, for example, the ultrasound systems described in connection with FIGS. 1-4.

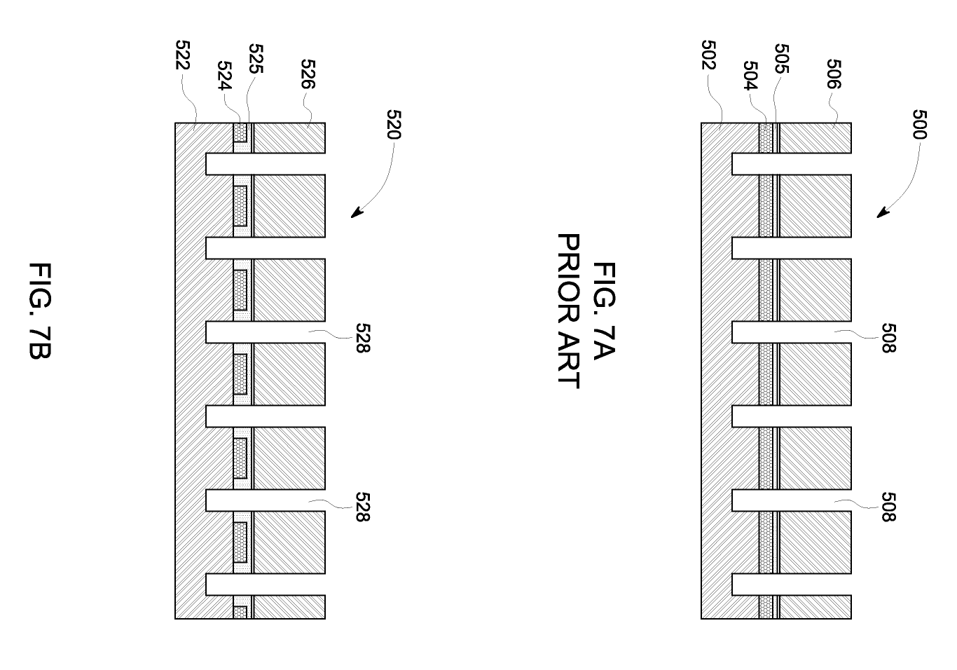

FIG. 5B illustrates a perspective view of layers of an acoustic stack 520 of an ultrasound transducer in accordance with an embodiment of the present invention. The acoustic stack 520 includes a plurality of layers 525 including a dematching layer 526 that includes a plurality of layers and a flexible circuit that includes a non-conductive layer 522, e.g., comprising Kapton®, and a conductive layer including a plurality of substantially parallel strips of conductive material 524, e.g., comprising copper. The strips of conductive material 524 are attached to a top surface of non-conductive layer 522. The conductive material 524 and the non-conductive layer 522 are secured to the dematching layer 506 using an adhesive 525 (shown in FIG. 7B), and then a dicing operation is executed to provide a plurality of substantially parallel cuts 528 (shown in FIG. 7B) that extend through the dematching layer 526, through the adhesive 525 and into the non-conductive layer 522, without cutting into or through the conductive material 524.

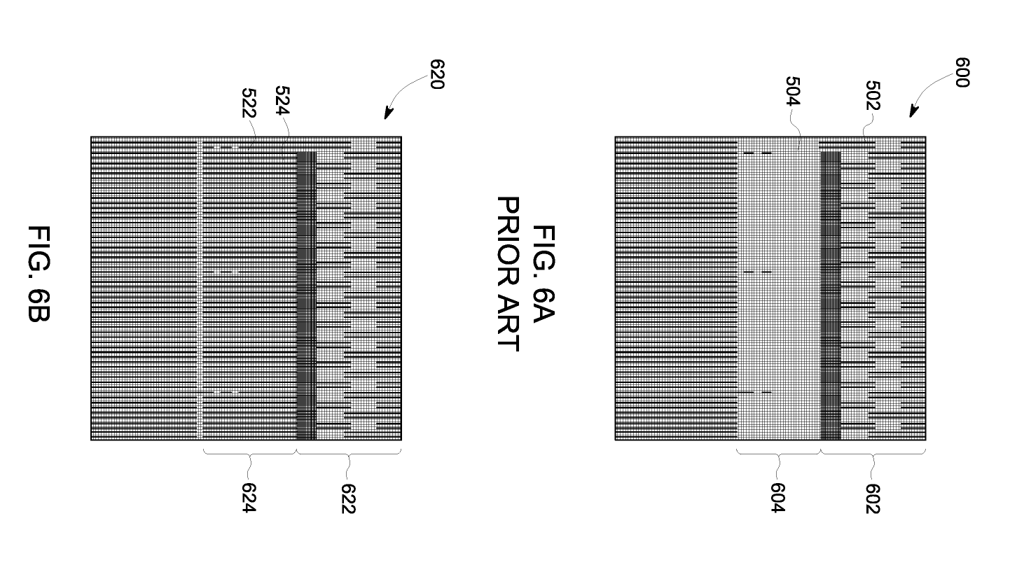

FIG. 6B illustrates a top view of a portion of the top surface 620 of the flexible circuit of the inventive ultrasound transducer of FIG. 5B. As depicted in FIG. 6B, the top surface 620 of the flexible circuit of the inventive ultrasound transducer of FIG. 5B includes an active area 622 and a ground area 624. The surface of the active area 622 has portions where the non-conductive layer 522 is exposed (indicated by the darker portions) and areas where the conductive material 524 is exposed (indicated by the lighter portions). Likewise, the surface of the ground area 624 has portions where the non-conductive layer 522 is exposed (indicated by the darker portions) and areas where the conductive layer 524 is exposed (indicated by the lighter portions). In the embodiment shown, the surface of ground area 624 has alternating strips of conductive and non-conductive material exposed for adhesion to the dematching layer 526 using adhesive 525 (shown in FIG. 7B).

FIG. 7B illustrates a side-sectional view of the acoustic stack 520 of the inventive ultrasound transducer depicted in FIG. 5B taken at the ground area 624 depicted in FIG. 6B. As depicted in FIG. 7B, each cut 528 is aligned with a portion of the top surface of the flexible circuit that has non-conductive material exposed such that each cut 528 extends through dematching layer 526, through adhesive 525 and into non-conductive layer 522 without passing through a strip of conductive material 524. As depicted in FIG. 7B, this results in adhesive 525 encapsulating each strip of conductive material 524 on three sides, including the top surface and both sides of each strip of conductive material 524. Only the bottom surface of each strip of conductive material 524 does not contact adhesive 525. Rather, the bottom surface of each strip of conductive material 524 is attached to the top surface of non-conductive layer 522. As depicted in FIG. 7B, the portion of the upper surface of non-conductive layer 522 that is exposed, i.e., provided between the strips of conductive material 524, contacts and adheres to adhesive 525, thereby providing adherence between non-conductive layer 522 and dematching layer 526 via adhesive 525.

While FIGS. 5B, 6B and 7B depict an embodiment that employs strips of conductive material and cuts aligned such that they do not pass through the strips of conductive material, other configurations can be used. For example, in an embodiment, a conductive layer can include a plurality of holes that allow the upper surface of the non-conductive layer to be exposed to the adhesive. In such an embodiment, cuts made during the dicing operation would extend through the conductive material and may or may not coincide with the exposed upper surface of the non-conductive layer. For example, in another embodiment, strips of conductive material may provided as shown in FIG. 5B, and cuts made during a dicing operation may be made substantially perpendicular to the strips such that the cuts and the strips intersect at a substantially right angle.

A technical effect of at least one embodiment is that an acoustical stack of an ultrasound transducer is provided that exhibits improved adhesion between the flexible circuit and the dematching layer in the ground area of the flexible circuit.

Methods of making and using an ultrasound transducer with an inventive acoustic stack configuration, as described above, for example, are also contemplated and are considered to be part of the present invention.

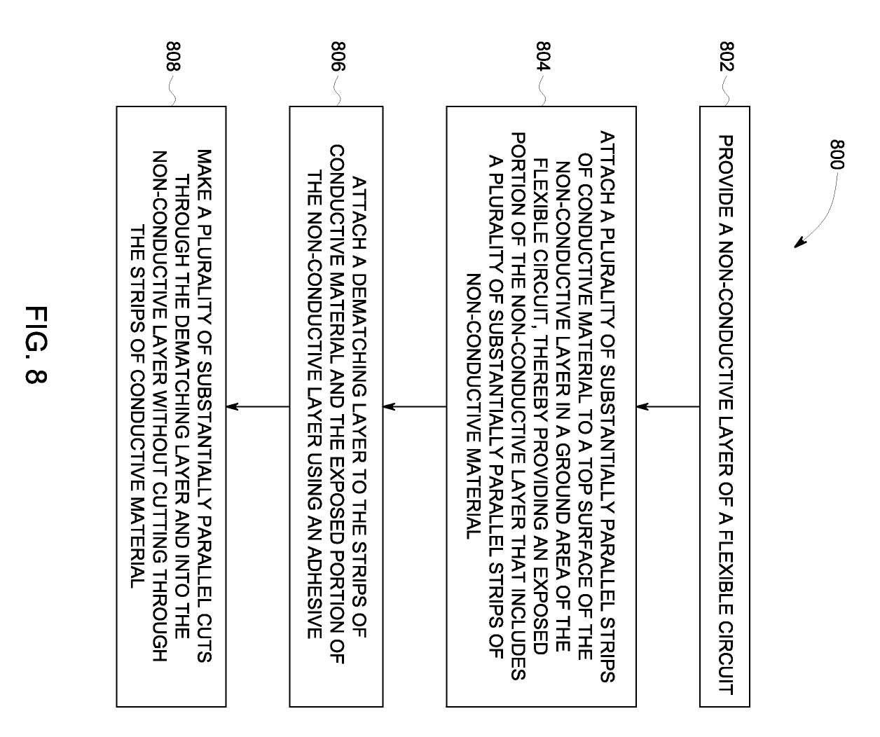

FIG. 8 illustrates a method 800 of forming an acoustic stack of an ultrasound transducer in accordance with an embodiment of the present invention. At 802, a non-conductive layer of a flexible circuit is provided. At 804, a plurality of substantially parallel strips of conductive material are attached to a top surface of the non-conductive layer in a ground area of the flexible circuit, thereby providing an exposed portion of the non-conductive layer that includes a plurality of substantially parallel strips of non-conductive material. At 806, a dematching layer is attached to the strips of conductive material and the exposed portion of the non-conductive layer using an adhesive. At 808, a plurality of substantially parallel cuts are made through the dematching layer and into the non-conductive layer without cutting through the strips of conductive material. Forming an acoustic stack of an ultrasound transducer as described in connection with FIG. 8 and/or other embodiments described herein may provide for improved adhesion between a flexible circuit and a dematching layer in the ground area of the flexible circuit.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. While the dimensions and types of materials described herein are intended to define the parameters of the invention, they are by no means limiting and are exemplary embodiments. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. §112, sixth paragraph, unless and until such claim limitations expressly use the phrase “means for” followed by a statement of function void of further structure.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. An ultrasound transducer including an acoustic stack comprising:
a dematching layer;
a flexible circuit including a nonconductive layer and a conductive material disposed on the nonconductive layer, the conductive material including a plurality of substantially parallel strips;
adhesive provided between the dematching layer and the flexible circuit such that the adhesive contacts the strips of conductive material and portions of the nonconductive layer between the strips of conductive material; and
a plurality of substantially parallel cuts that extend through the dematching layer, through the adhesive and into the nonconductive layer without cutting into the strips of conductive material.

2. The ultrasound transducer of claim 1, wherein the flexible circuit includes a ground area, and wherein the strips of conductive material and the cuts are located on the ground area.

3. The ultrasound transducer of claim 1, wherein the adhesive encapsulates each strip of conductive material on three surfaces, including a top surface and two sides of each strip of conductive material, and wherein a bottom surface of each strip of conductive material is attached to the nonconductive layer.

4. The ultrasound transducer of claim 1, wherein the conductive material comprises copper.

5. The ultrasound transducer of claim 1, wherein the nonconductive material comprises Kapton®.

6. An ultrasound system including a transducer including an acoustic stack comprising:
a dematching layer;
a flexible circuit including a nonconductive layer and a conductive material disposed on the nonconductive layer, the conductive material including a plurality of substantially parallel strips;
adhesive provided between the dematching layer and the flexible circuit such that the adhesive contacts the strips of conductive material and portions of the nonconductive layer between the strips of conductive material; and
a plurality of substantially parallel cuts that extend through the dematching layer, through the adhesive and into the nonconductive layer without cutting into the strips of conductive material.

7. The system of claim 7, wherein the flexible circuit includes a ground area, and wherein the strips of conductive material and the cuts are located on the ground area.

8. The system of claim 7, wherein the adhesive encapsulates each strip of conductive material on three surfaces, including a top surface and two sides of each strip of conductive material, and wherein a bottom surface of each strip of conductive material is attached to the nonconductive layer.

9. The system of claim 7, wherein the conductive material comprises copper.

10. The system of claim 7, wherein the nonconductive material comprises Kapton®.

11. A method of forming an acoustic stack of an ultrasound transducer comprising:
attaching a plurality of substantially parallel strips of conductive material to a nonconductive layer of a flexible circuit;
using an adhesive to bond a dematching layer to the strips of conductive material and portions of the nonconductive layer between the strips of conductive material; and
providing a plurality of substantially parallel cuts that extend through the dematching layer, through the adhesive and into the nonconductive layer without cutting into the strips of conductive material.

12. The method of claim 11, wherein the flexible circuit includes a ground area, and wherein the strips of conductive material and the cuts are located on the ground area.

13. The method of claim 11, wherein the adhesive encapsulates each strip of conductive material on three surfaces, including a top surface and two sides of each strip of conductive material, and wherein a bottom surface of each strip of conductive material is attached to the nonconductive layer.

14. The method of claim 11, wherein the conductive material comprises copper.

15. The method of claim 11, wherein the nonconductive material comprises Kapton®.
